(19) United States
(12) Patent Application Publication
(10) Pub. No.: US 2008/0059543 A1
(43) Pub. Date: Mar. 6, 2008

(54) ESA enablement of records management for application integration

(76) Inventor: Andreas Engel, Weinheim (DE)

Correspondence Address: KENYON & KENYON LLP, 1500 K STREET N.W., WASHINGTON, DC, 20005, US

(21) Appl. No.: 11/515,144

(22) Filed: Aug. 31, 2006

(51) Int. Cl. G06F 17/30

(52) U.S. Cl. 707/204; 707/200

(57) ABSTRACT

Systems and methods for archiving documents are described that permit the integration of a centralized archive management system (“AMS”) into various applications in a streamlined fashion. An application may generate metadata from a document to be archived and place the metadata and document into a document archival and retention request. The application may send the request to the AMS. A AMS may be constructed that derives a document policy from the metadata. A policy interpreting engine translates the policy into database instructions. The policy interpreting engine may pass the database instructions to a policy executing engine. The policy executing engine may perform the necessary operations on the database to store the document and the associated policy.

### BACKGROUND

Companies employ a large, diverse suite of computer applications to support their daily operations. Today, each application must individually manage the archival and retention of documents to satisfy corporate policies or legal requirements. As such, standardizing and enforcing document retention policies is difficult across applications. It is preferable to employ a centralized archive management system (“AMS”) to manage these retention policies. Often, cost considerations dictate that a centralized document archival system is used that can service multiple applications simultaneously. Each time a document is generated by an application, a corresponding policy may be generated to govern how that document is to be archived and how long it is to be retained. The document archival system interprets the policy and stores the document in accordance with the policy. The document archival system may also expunge the document once the time for retention has expired.

Document archiving and retention policies may vary from application to application and department to department. Integrating these applications with document storage systems may be costly because applications and document storage systems lack a unified interface by which to exchange document policies. Today, the AMS and applications are tightly coupled so that policies from one application must be interpreted by specific code on the respective AMS. The result is that companies must develop custom patches on both the application and document storage system sides. The custom patches for the applications generate data that represent policies for the documents, and those on the AMS interpret the generated policy data. Creating these custom patches often translates into higher costs for companies and is difficult to administer. This is so because implementing corporate-wide policies requires customizing patches for each application and thus also customizing each corresponding application-specific patch on the AMS. Thus a centrally administered policy administration system is desirable that leverages a unified interface to generate policies for documents originating from various applications, thereby avoiding the need for custom patches on the AMS and permitting document policies to be more easily administered in a centralized location.

### BRIEF DESCRIPTION OF THE DRAWINGS

FIG. 1 depicts a block diagram of an embodiment of the present invention.

FIG. 2 depicts exemplary workflows of an embodiment of the present invention.

FIG. 3 depicts a flowchart of illustrative steps of one embodiment of the present invention.

### DETAILED DESCRIPTION

Embodiments of the present invention provide a generic interface to a centralized AMS for archiving documents and implementing document retention policies in the AMS. An AMS may receive an incoming document archival and retention request, the request containing a document and document metadata. The AMS may pass the document metadata to a derivation engine that may derive a document policy from the document metadata. The derivation engine may be adapted to interpret document metadata from multiple sources, and in this way the invention may avoid the need for custom patches on the AMS to parse the metadata from the multiple sources. A policy interpreting engine may translate the resulting document into database instructions. A policy executing engine may perform the database instructions and archive the document and document policy in a database.

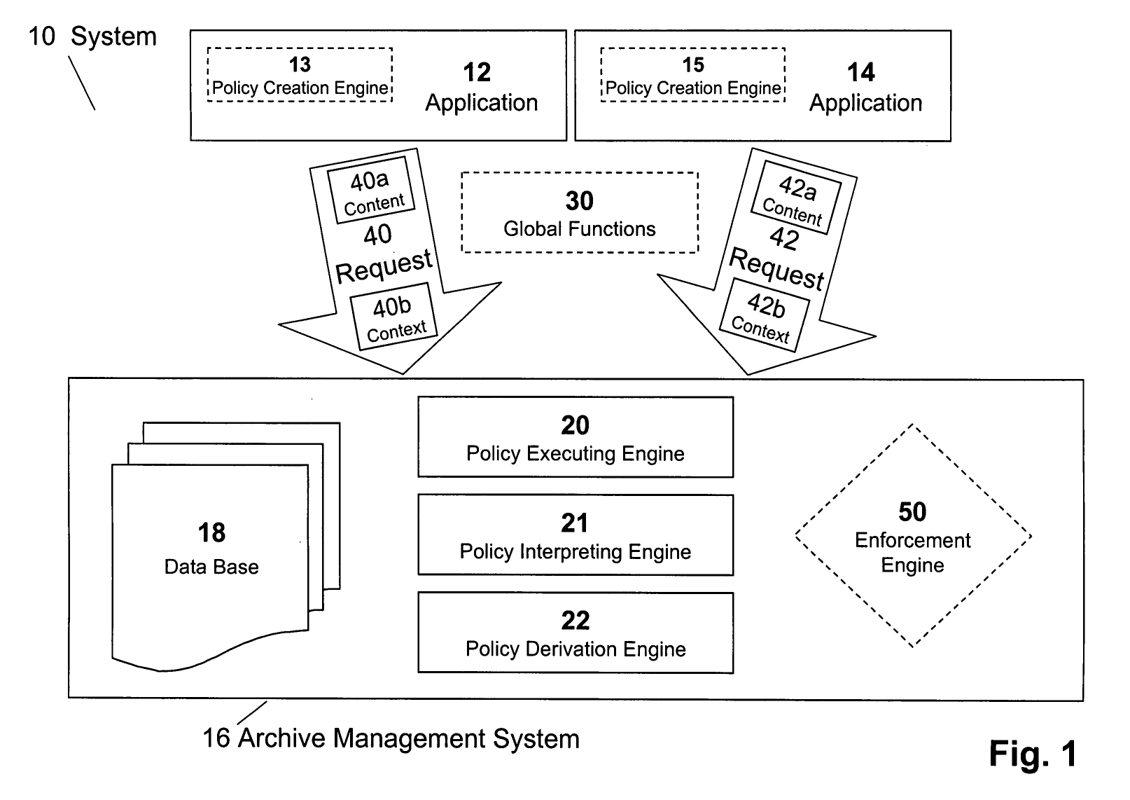

FIG. 1 depicts a block diagram of the system 10 of the present invention. The system 10 includes a AMS 16 that includes a database 18, a derivation engine 22, a policy executing engine 20, and a policy interpreting engine 21. The derivation engine 22 may generate document policies from incoming document archival and retention requests 40 and 42, the requests including a document and document metadata. The policy interpreting engine 21 may parse the document policies and may control operation of the policy execution engine 20 to archive the documents. The policy executing engine 20 may execute the translated instructions it receives from the policy interpreting engine 21 by performing operations on the database 18 in accordance with those instructions. The database 18 may be a storage device to store the documents and their associated retention policies. Database 18 fields incoming document archival and retention requests 40 and 42. The incoming requests 40 and 42 may include documents and document policies that specify how those documents are to be archived and retained within AMS 16. The document policies may have been generated to conform to a universal policy creation specification. The AMS 16 may be a centralized document storage system for archiving documents and enforcing their associated document retention policies.

The AMS 16 may be a system that archives and manages the retention of documents generated by various applications. The AMS 16 may include a database 18 that archives documents in various forms as well as the document policies that outline the document retention policies for those documents. The AMS 16 may archive documents by receiving a document and storing the document in the database 18 in accordance with the document policy for that document. Because of the archival nature of the AMS 16, the documents archived by the database 18 may typically exist as static records. The AMS 16 may store documents in various forms, both single file documents as well as more complex multipart documents. AMS 16 may store document policies in a way such that AMS 16 may determine which document policy corresponds to which document. This may be accomplished by the database 18 maintaining reference pointers or unique reference numbers that map documents to policies and vice versa. The AMS 16 may manage the retention of documents by enforcing the document policies for those documents, expunging the documents whose expiration dates have passed.

Upon receiving an incoming document archival and retention request, the AMS 16 may extract the document metadata within the request and pass the metadata to the derivation engine 22. Derivation engine 22 may be adapted to parse the metadata and to generate document policies therefrom by applying derivation rules on the metadata. The derivation engine 22 may include rules whose conditions match particular data within the metadata. The output of the rules may be policy instructions. The derivation engine 22 may assemble the policy instructions output by applying the derivation rules into a document policy and pass the document policy to a policy interpreting engine 21. The document policies may correspond to corporate policies for how the document is to be archived and retained. The rules may be adapted to be applied to document metadata received from various applications. In this way, a single derivation engine 22 may translate document metadata from multiple applications without the need to create custom hardware or software components for each application.

The derivation engine 22 may pass the generated policies to the policy interpreting engine 21 where the policies are translated into database instructions. The policy interpreting engine 21 may apply translation rules that translate specific instructions within the policies into database instructions. The policy execution engine 20 may receive a document from AMS 16 and the translated instructions from the policy interpreting engine 21, the translated instructions encoding the interpreted policy for that document. The AMS 16 may extract the document from the document archival and retention request. The policy executing engine 20 may pass the document to the database 18 for storage. The translated instructions may be used to invoke database interface functions to store the document in whatever method is specified in the instructions. The policy interpreting engine 21 and policy executing engine 20 are depicted as separate components for ease of description, but it is contemplated that they may be integrated into a single component.

The above discussion describes a system for archiving and executing document retention policies in a centralized document storage system on documents created by various applications. By sending metadata to the AMS and having the AMS derive the policy from the metadata, the system avoids the need to create costly application-specific patches within the AMS to interpret the document metadata generated by the specific application. The following discussion illustrates various embodiments of the present invention and is not meant to limit the scope of the present invention.

Applications 12 and 14 may generate documents to be archived as part of enterprise work product. The applications may package the documents with metadata into document archival requests 40 and 42. Applications 12 and 14 may then send the requests to the AMS 16. At the AMS 16, the derivation engine 22 may generate a policy containing archival and retention instructions from the context metadata, the metadata including data such as the author of the document, date of creation, department from which the document originates, etc. The policy interpreting engine 21 may then translate the policy instructions into database instructions. The policy interpreting engine may then pass the database instructions to a policy executing engine 20. The policy executing engine 20 may then perform the necessary operations on the database 18 based on the database instructions it receives to archive the document.

In one embodiment, applications 12 and 14 may be enterprise applications that generate work product as a result of users using the applications. Such work product may include creating memoranda, generating spreadsheets, sending email, creating accounting ledgers, etc. This work product, in addition to being stored locally, may be archived in a central document storage system or a dedicated storage system on the department or application level. AMS 16 may store various document types to archive the variety of documents generated by the applications 12 and 14. The particular embodiments of the applications 12 and 14, AMS 16, and communication there between, unless otherwise specified, are immaterial to the invention and are provided solely for illustrative purposes. For purposes of this discussion, application 12 may be an email program and application 14 may be an accounting ledger program.

Application 12 may package the created document and metadata about the document in the document archival and retention request 40. The request 40 may contain a content portion that contains the document and a context portion that contains the metadata. Metadata may be information that AMS 16 uses to derive the appropriate policy to apply to the document.

The metadata may contain information specific to the document, such as the author, the application used to create the document, the title of the document, recipients, the date it was created, etc. The metadata may also contain information apart from the document, such as the department that generated the document, etc. The following table represents various descriptions of policies that may be generated from specific types of metadata.

| Type of Metadata | Policy Description |
|---|---|
| document author | Store documents authored by company |
| | executives for five years. |
| document title | Archive documents with “contract” in the |
| | title in pdf format (to prevent tampering) |
| documents from the | Store documents from accounting |
| accounting department | department, regardless of what type of |
| | documents they are for seven years (to |
| | comply with Sarbanes Oxley rules) |
| documents categorized | Store merger documents indefinitely (with |
| as related to merger | no expunge date) |
| personal files (may be | Store personal documents for one month. |
| determined to be personal | |
| by identifying keywords such | |
| as “mother” or “vacation.”) | |
| Default | Store any documents not covered by any |
| | policy for three years. |

Application 12 may format the metadata so that the derivation engine 22 may parse the information. Application 12 may organize the metadata by applying various, predefined formats, such as placing data in predefined slots of a string of metadata or organizing data according to field and value pairs. In a slotted string, the first 50 characters may be devoted to metadata of a particular type (such as the author of the document). A second 50 characters may encode the title of the document. In the case of field and value pairs, the fields may be predefined fields that signify what type of data will be included in the value portion of the pair. The derivation engine 22 may be configured to recognize these fields and process the data in the value portions. Alternatively, application 12 may simply construct the metadata without a predefined structure and rely on derivation engine 22 to parse the information. The specific implementation of the format of the metadata is immaterial to the description of the invention unless otherwise specified and is described only for illustrative purposes.

Application 12 may send the request 40 to AMS 16, where a derivation engine 22 may derive an appropriate policy from the context metadata. Derivation engine 22 may include predefined rules that signify what policies to apply to particular metadata. Derivation engine 22 may first parse the context metadata. Once the metadata is parsed, the derivation engine 22 may apply the predefined rules to the metadata. The output of the rules may be policy instructions that define how the document is to be archived and retained. To illustrate, application 12 may have formatted the metadata as field and value pairs. One predefined field may include the application that generated the document related to the metadata. For application 12, that would be the name of the email application. The derivation engine may parse this first field and value pair, determine that the first field relates to the name of the application, and interpret the first value to be the name of the application. The derivation engine 22 may then determine that the first value indicates that the document came from an email program. The derivation engine may include a predefined rule that indicates that any documents originating from email programs are to be retained for three years. The output of the rule may be a policy instruction that contains the instruction to retain the document for three years. The derivation engine may include this database instruction in a policy. The derivation may parse the remainder of the context metadata and output any additional instructions as necessary. The derivation engine 22 may pass the generated policy to policy interpreting engine 21 to be parsed.

Derivation engine 22 may generate policies from various types of metadata, such as from document specific information, information outside the document, predefined categories of information, etc. Document specific information may include the author, date of the document, any recipients, the title of the document, or any other content within the document. A derivation engine rule may map all documents authored by executives into a policy instruction to store the document for 5 years. The derivation engine 22 parsing this metadata may determine that the type of metadata type is the document author, extract the value (which is the actual author), and compare the actual author against a list of employees and their roles within the company. Another rule may map any document with a From, To, or CC to the SEC into a rule to store the document for seven years to comply with the Sarbanes Oxley rules.

Another set of rules may map documents with metadata about the document, not taken strictly from within the document, into policy instructions. These rules may include information that the application may gather from the environment from where the document originates. For example, a derivation engine rule may specify that documents from the human resources department be stored for only one year. The application 12 may insert this data (e.g. with a field value pair of “department=HR”) into the metadata. Other rules may specify that documents contained within personal folders are only to be kept for one month, to provide simple back up of the data therein.

Still further, derivation engine 22 may contain rules that may map information not specific to a particular document or the surrounding document information into a policy. The application may classify the document and send the classification to the AMS. A corporate policy may determine that all documents related to the acquisition of a subsidiary are to be kept indefinitely. These documents may originate from various programs. The derivation engine 22 may receive a document and a string such as “Acquisition” for an email generated about the acquisition. The derivation engine 22 may include code that recognizes the “Acquisition” document type and may generate a policy such as StoreDocumentAsNative. Again, since these are designated not to expire, no RetainDocumentForTime instruction may be required. A policy derivation engine may also derive default corporate policies that cover all documents not already covered by another policy.

Documents and document policies may exist in a many to one relationship. That is, a single document policy may be applied to various documents by the derivation engine 22. For example, a single policy may state that all accounting department documents are to be stored for seven years.

The policy interpreting engine 21 may include a set of rules that map policy instructions to database instructions, and in this way, the policy interpreting engine 21 may translate the policy instructions into database instructions. Where the database 18 is a combination of a computer file system for storing documents and an SQL or relational database for storing the document policy, a first rule may map an archive document instruction into a file system call that takes as input the document to be stored and a complete path and file name for the location where the document is to be stored. A table may exist in the policy portion of database 18 that contains the fields “Path”, “Filename”, “ArchivalDate”, “RetentionTime”, and “Units”. A second rule may exist that maps a “RetainDocumentForTime” instruction, with parameters Time and Units, into an SQL statement to create a record in the table for this instruction. Upon encountering these instructions, the policy interpreting engine 21 may pass the corresponding file system call and SQL statement to the policy executing engine 20. Of course, the derivation engine 22 may bypass the policy interpreting engine 21 and generate the database instructions as the output data set and pass the data set directly to the policy executing engine. The rules within the derivation engine 22 may simply translate from incoming context metadata to database instructions directly in this case.

The policy executing engine 20 may receive the database instructions and invoke the necessary database functions to execute the instructions. The database may return a code indicating whether the operations were successful. The policy executing engine 20 may pass the return code back to the AMS 16 to be delivered in a response back to application 12.

Like application 12, application 14 may also generate a document and metadata, package the document and metadata into a request 42 by placing the document into the content portion 42a and the metadata into context portion 42b. The application 14 may pass the request 42 to AMS 16, and the derivation engine may interpret the metadata therein into policy instructions to be passed to the policy interpreting engine 21. Because the derivation engine uses a predefined set of rules to parse metadata formatted in predefined ways, the derivation engine may parse metadata from application 12 and 14 without requiring a separate derivation engine to be created for each application. In this way, the cost normally associated with integrating applications into an AMS is avoided, and enforcement of retention policies is more precise. For example, derivation engine 22 may include a rule that maps any document from the accounting department into a retention instruction to keep the document for five years. Both applications 12 and 14 may exist in the accounting department, despite the fact that application 12 is a generic email program. Both metadata from applications 12 and 14 may include a field and value pair indicating that the documents generated therefrom originated from the accounting department. The single derivation engine 22 may then parse the metadata from applications 12 and 14 regardless of the fact that they are different applications. Derivation engine 22 may apply the accounting department rule and generate the appropriate policy instructions to retain documents from both applications 12 and 14 for five years.

In an alternative embodiment, the applications 12 and 14 may generate the document archival and retention policies themselves, include the policies in requests 40 and 42, and allow AMS 16 to interpret these policies by passing them directly to policy interpreting engine 21. In this way, derivation engine 22 may be bypassed. Application 12 may generate the document archival and retention policy for a document to be stored using a universal policy creation specification. The policy may include an encoded set of instructions based on pre-determined corporate policies for how the document is to be stored and how long it is to be retained within the document storage system. The universal specification may include rules that determine what types of instructions may be included in policies and what format those instructions are to take. Program code may exist as part of application 12 that generates policy instructions conforming to the universal policy creation specification. The specific set of instructions supported by the universal specification, unless specified, are immaterial to this invention but may include such instructions as “ArchiveDocumentAsNative”, “ArchiveDocumentAsImage”, and “RetainDocumentForTime”.

An instruction within a policy may include necessary parameters as well as the instruction itself. For example, an instruction “ArchiveDocumentAsImage” may include one of various parameters instructing the AMS 16 to store the document in a particular image format. These image formats may include Tif, Gif, Jpeg, PDF, etc. In addition to parameters taken from a set of possible values, parameters may fall within a range of possible values. The parameters for the “RetainDocumentForTime” instruction may include valid values of X>0. That is, an instruction to retain a document for X amount of time may be any time greater than 0. Instructions may also contain not just one parameter but may contain multiple values. The “RetainDocumentForTime” instruction may also include units of time, such as hours, minutes, weeks, or days. In practice, the specific instructions may vary and are, unless specified, immaterial to this invention. The specification may also determine what format the instructions of the policy is to take, such as a set of XML codes, a string of instruction/parameter pairs, etc.

In one embodiment, corporate policy may dictate that emails generated by application 12 are to be kept for three years while accounting ledgers generated by application 14 are kept for seven years. Furthermore, accounting ledgers may be stored in an image format to prevent subsequent tampering with the figures therein.

The rules for the universal policy creation specification may be broken down into three types, valid value rules, instruction specific rules, and format rules. In this embodiment, the format rules may be as follows:

A policy may be a contiguous string of comma separated instructions of the form Instruction1, Instruction2, . . .

An instruction may be of the form InstructionName/Parameters.

Parameters may be a colon (‘:’) separated list of individual parameters of the form Parameter1:Parameter2: . . .

Valid value rules may be as follows:

Valid instructions may be “StoreDocumentAsNative”, “StoreDocumentAsImage”, and “RetainDocumentForTime”.

Valid values for the length of time parameter of RetainDocumentForTime may be X>0 where X is the length of time.

Valid values for the units of time parameter of RetainDocumentForTime may be “years”, “months”, “weeks”, and “days”.

Valid values for the image type parameter of StoreDocumentAsImage may be “tif”, “gif”, “jpg”, and “pdf”.

Individual instruction rules may be as follows:

Instruction StoreDocumentAsNative: contains no parameters.

Instruction RetainDocumentForTime: contains a first parameter, length of time and a second parameter units of time.

Instruction StoreDocumentAsImage: contains one parameter, image type.

The policies may be a string of comma separated instruction/parameter pairs represented in a textual form. The parameter list for a particular instruction may be a colon (‘:’) separated list of parameters. Thus, employing this specification, the policy for an email generated by application 12 may thus be StoreDocumentAsNative,RetainDocumentForTime/3:years where StoreDocumentAsNative are the instructions, 3 is the parameter of length of time, and years is the parameter for the unit of time. Policies for application 14 may be StoreDocumentAsImage/PDF,RetainDocumentForTime/7:years.

Once the policy is generated, application 12 may package the generated policy in a document storage request 40 and send the request 40 to AMS 16. The requests 40 and 42 may include content portions 40a and 42a that each holds a document to be archived and context portion 40b and 42b that each holds the document policy for the respective document. The document may thus be the substance of the document request while the policy of the context portion may be the meta data that determines how to archive the document.

Similarly, application 14 may generate a document, create a policy using policy creation engine 15, package the document and policy in a request 42, and send the request 42 to AMS 16 for processing. Like policy creation engine 13, policy creation engine 15 may implement the universal policy creation specification and may create policies that are automatically interpretable by the AMS 16 without requiring custom translation engines to be created. In this way, the cost normally associated with creating custom patches to interpret and translate the policies from various applications may be minimized.

Once the AMS 16 receives the document archival and retention request 40, it may extract the policy from the context portion 40b of the request 40 and pass that policy to the policy interpreting engine 21. The policy interpreting engine 21 may then parse the policy and generate a set of database instructions that are used by the policy executing engine 20 to carry out the instructions within the policy. Again, because the policy may have been created in accordance with the universal policy creation specification, the policy interpreting engine 21 may decipher the instructions in the policy regardless of what application generated the policy. Receiving the policy earlier created by application 12, the policy interpreting engine 21 may use the first rule to parse the incoming policy. The policy interpreting engine may receive the policy, “StoreDocumentAsNative,RetainDocumentForTime/3:years”. The policy interpreting engine 21 may break the policy down into instructions by breaking the string wherever it finds a comma. This may result in a set of two instructions, StoreDocumentAsNative and RetainDocumentForTime/3:years. Next, the first instruction may be parsed using the second rule. Since it contains no ‘/’, StoreDocumentAsNative may be deemed to be the instruction name. The policy interpreting engine 21 may check StoreDocumentAsNative against the valid instruction names and determine that it is indeed a valid instruction.

For the second instruction, the portion to the left of the ‘/’, RetainDocumentForTime may be determined to be the instruction name while 3:years may be the parameters list. RetainDocumentForTime may be determined to be a valid instruction name by comparing it to the list of valid instructions. The third rule may be applied to separate the parameters by the ‘:’. The parameters “3”, in the length of time position and “years” in the units of time position may be checked against the valid values for those parameters and checked to see if they occur in the appropriate positions in the RetainDocumentForTime instruction rule. Similar operations may be performed on the policy originating from application 14. Despite originating from a different application and containing different parameters, the policy interpreting engine 21 may still interpret the policy from application 14 since it conforms to the universal policy creation specification above.

In one embodiment, applications 12 and 14 may use global functions 30 to generate document policies. Global functions 30 may contain code to generate policies that conform to the universal policy creation specification. The policies generated by both applications 12 and 14 using global functions 30 are interpretable by AMS 16 because the global functions 30 encode instructions that conform to the creation specifications. For each aspect of the corporate policy, the applications 12 and 14 may generate the document policy by calling the specific global function that encodes the corresponding instruction and passing it the necessary parameters. Referring to the above embodiments, global functions 30 may include a function StoreDocumentAsNative( ) that corresponds to the instruction “StoreDocumentAsNative”, a function RetainDocumentForTime(time, unit) that corresponds to “RetainDocumentForTime”, etc. The output of the global functions 30 may be specific instructions or set of instructions. These instructions may be assembled to generate a complete policy. Global functions 30 may exist as methods downloaded by the applications 12 and 14, may be invoked remotely via remote procedure calls, or may otherwise be globally accessible by applications 12 and 14. Using the global functions 30 replaces the need to separately code the instructions in each application, streamlines the integration of the AMS 16 into the applications 12 and 14, and thereby reduces the time and cost of integration. Furthermore, updates to the instructions handled by the AMS 16 may be quickly propagated to the applications 12 and 14 by encoding the updates in the global functions 30. By accessing the updated functions, applications 12 and 14 may quickly gain the ability to generate the updated instruction set.

In another embodiment, an enforcement engine 50 may expunge documents whose retention time has expired. Once a document has been archived, an enforcement engine 50 may be invoked by policy executing engine 20 to enforce the document retention policies of the already stored documents. The enforcement engine 50 may retrieve each stored policy in database 18 and determine whether the document associated with that policy needs to be expunged from the database. The enforcement engine 50 may compare the current date with the date stored in an expiration date field of a document policy. If the document has indeed expired, the policy executing engine 20 may generate and execute a database instruction to remove the document and its associated policy from the database 18. By automatically managing the removal of expunged documents, the AMS 16 minimizes the amount of interaction necessary between the applications 12 and 14. The applications 12 and 14 thus need not maintain local records of when documents are to scheduled to expire or run periodic checks to determine whether the retention policies are executed.

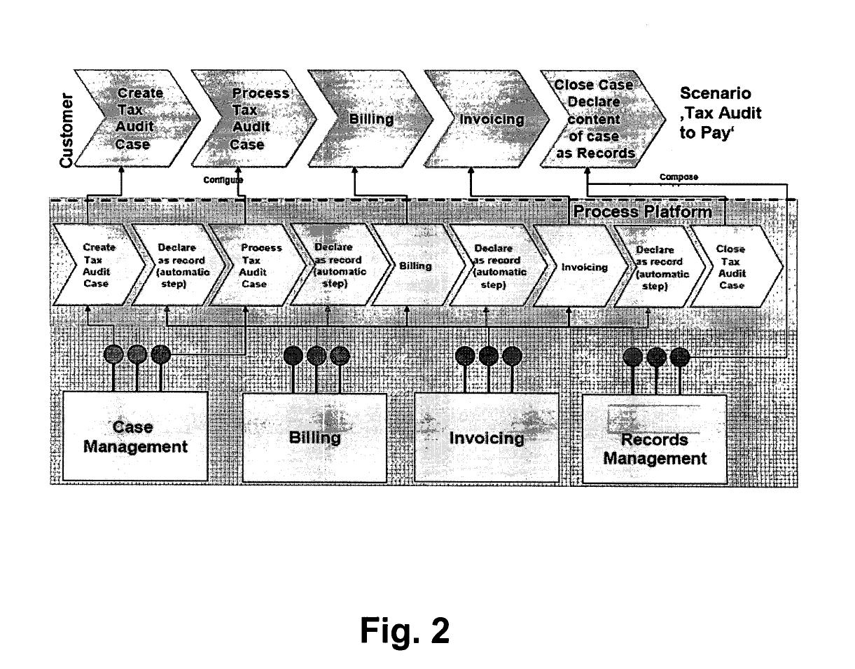

In one embodiment, the applications 12 and 14 may use various schemes to schedule when records are sent to the AMS. In some instances, human input may be used to initiate the process of sending documents. In others, the documents may be sent automatically, depending on the schedule or workflow of the application. FIG. 2 depicts two exemplary workflows. In the first workflow, the document may explicitly be saved to the AMS along with its associate policy upon closing the application. In this case, the user may explicitly instruct the application to store the document or the application may perform this action automatically.

In the second instance, the document may automatically be saved at each step of the workflow. Instead of requiring user input, the workflow may automatically store the document at each step of the workflow. In this way, a history of the document may be created.

In another embodiment, a security component may enforce access rights on documents in the repository. Each stored record may be associated with a security policy that determines, among other things, what individuals are allowed to retrieve the document, whether special credentials are required before the document is purged, whether a new version of the current document may be created, etc.

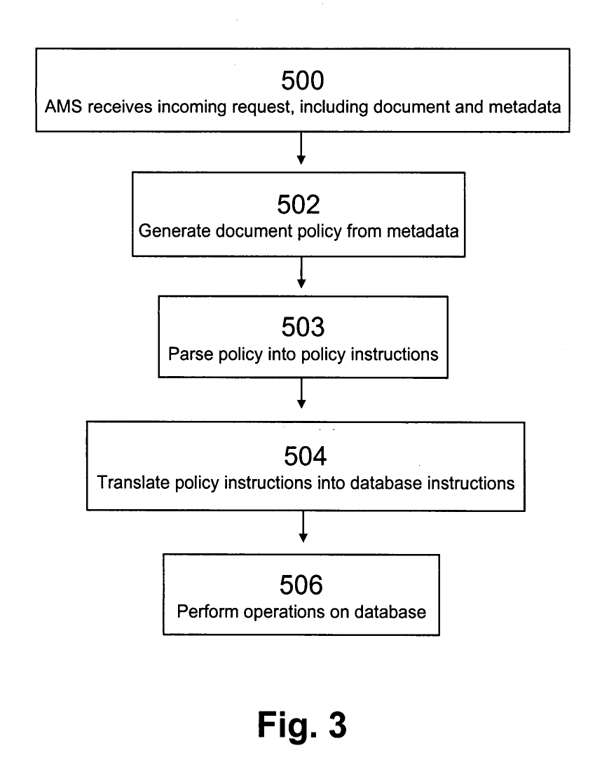

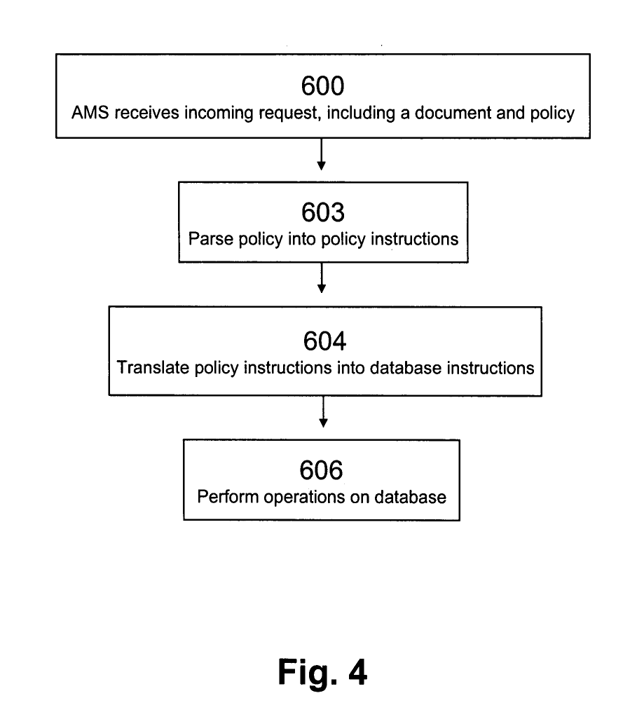

Turning to FIG. 3, a flowchart of illustrative steps of the present invention is depicted. In step 500, the AMS receives an incoming document archival and retention request. The request may be generated by an application and may include a document and document metadata. The document metadata may encode various aspects of the document. In step 502, a derivation engine may generate a document policy from the document metadata according to a set of derivation rules. In step 503, the derivation engine may pass the document metadata to a policy interpreting engine that parses the policy into policy instructions. In step 504, the policy interpreting engine may translate the policy instructions into database instructions. To aid translation, the policy interpreting engine may include rules that map policy instructions into database instructions. The database instructions may be passed to a policy executing engine, and in step 506, the policy executing engine may perform operations on the database in accordance with the database instructions.

In an alternative embodiment, a policy may be received by the AMS as part of the document request. The policy may have been created in accordance with a universal policy creation specification. In this case, the policy may be passed directly to a policy interpreting engine, bypassing the derivation engine. Thus, in FIG. 3, step 503 may follow immediately after step 500, bypassing step 502.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A system for storing and managing documents comprising:
a policy derivation engine, responsive to an incoming document archival and retention request, the request comprising a document and document metadata, for translating the metadata into a document policy;
a policy interpreter for translating the policy into database actions;
a policy executing engine for performing the database actions; and
a database for storing the document.

2. The archive management system of claim 1 further comprising:
the document archival and retention request having a context portion and a content portion;
the content portion comprising the document; and
the context portion comprising the document metadata.

3. The archive management system of claim 1 further comprising:
an enforcement engine for expunging the document once the time specified by the document metadata has expired.

4. The archive management system of claim 1 further comprising:
a security component within the archive management system for enforcing access and storage rights on the document.

5. A system for storing and managing documents comprising:
a policy interpreting engine responding to an incoming document archival and retention request, comprising a document and document policy metadata, the document policy metadata created in accordance with an universal policy creation specification, for translating the document policy metadata into database actions;
a policy executing engine for performing the database actions; and
a database for storing the document.

6. The archive management system of claim 5 further comprising:
the document policy created using a set of universally accessible global functions, the global functions adapted to produce policies that conform to the universal policy creation specification.

7. A method for archiving and retaining documents comprising:
responsive to an incoming document archival and retention request representing a document and document metadata, deriving a document policy from the document metadata;
translating the policy into database instructions; and
executing the database instructions.

8. The method of claim 6 further comprising:
the document archival and retention request having a context portion and a content portion;
the content portion comprising the document; and
the context portion comprising the document metadata.

9. The method of claim 6 further comprising:
expunging the document once the time specified by the document metadata has expired.

10. The method of claim 6 further comprising:
enforcing access and storage rights on the document.

11. A method for archiving and retaining documents comprising:
responsive to an incoming document archival and retention request representing a document and document policy metadata, the document policy metadata generated in accordance with a universal policy creation specification, interpreting policy instructions included in the document policy metadata;
translating the policy instructions into database instructions; and
executing the database instructions.

12. The method of claim 11 further comprising:
the document policy created using a set of universally accessible global functions, the global functions adapted to produce policies that conform to the universal policy creation specification.
